(19) United States
(12) Patent Application Publication
(10) Pub. No.: US 2012/0059692 A1
(43) Pub. Date: Mar. 8, 2012

(54) COMMODITY DATA PROCESSING APPARATUS, CONTROL METHOD THEREFOR, AND COMPUTER READABLE STORAGE MEDIUM

(75) Inventor: Rou Nemoto, Kanagawa (JP)

(73) Assignee: TOSHIBA TEC KABUSHIKI KAISHA, Tokyo (JP)

(21) Appl. No.: 13/219,839

(22) Filed: Aug. 29, 2011

(30) Foreign Application Priority Data
Sep. 2, 2010 (JP) 2010-196945

(51) Int. Cl. G06Q 30/00

(52) U.S. Cl. 705/14.1

(57) ABSTRACT

According to one embodiment, a commodity data processing apparatus includes a control unit. The control unit includes a calculating section, a price-reduction executing section, and a price-reduction informing section. The calculating section calculates a total amount of selling prices of purchased commodities on the basis of commodity data of the purchased commodities stored in a storing section. The price-reduction executing section reduces, if the total amount exceeds a reference amount and a price reduction target commodity is included in the purchased commodities, a selling price of the target commodity. The price-reduction informing section generates screen data for informing that the price reduction is performed.

### CROSS-REFERENCE TO RELATED APPLICATIONS

This application is based upon and claims the benefit of priority from the prior Japanese Patent Application No. 2010-196945, filed on Sep. 2, 2010, the entire contents of which are incorporated herein by reference.

### FIELD

Embodiments described herein relate generally to a commodity data processing apparatus that reduces a selling price of a specific commodity according to a total amount of commodities to be purchased, a control method for the commodity data processing apparatus, and a computer readable storage medium.

### BACKGROUND

In the past, if a total selling price of commodities purchased in one transaction exceeds a reference amount set in advance and a specific commodity is included in commodities subjected to sales registration, a sales activity for reducing a selling price of the specific commodity through a price-cut or a discount is performed in various stores. If such a sales activity is performed, a customer has an incentive to purchase commodities until a total selling price reaches the reference amount. A store can expect an increase in sales.

Registration of commodities to be purchased is performed using a POS (Point Of Sales) terminal or an ECR (Electric Cash Register). It takes time for a store clerk or a customer to check, while the store clerk or the customer operates the apparatus of this type and subjects commodities to sales registration, whether a total selling price of registered commodities exceeds the reference amount and the specific commodity is included in the registered commodities. It is not unlikely that the progress of checkout is delayed. Therefore, it is not easy to learn realization of a price reduction during work for registering commodities. The store clerk or the customer who is an operator of the apparatus could be uncertain of whether the price reduction is appropriately performed and feel uneasiness.

Because of such circumstances, if a total selling price of commodities to be purchased exceeds the reference amount and a price reduction is realized, it is necessary to take measures for the operator to easily learn the realization of the price reduction and the contents thereof.

### BRIEF DESCRIPTION OF THE DRAWINGS

FIG. 1 is a block diagram of a main part configuration of a POS terminal in an embodiment;

FIG. 2 is a memory diagram of a RAM included in the POS terminal in the embodiment;

FIG. 3 is a block diagram of functions realized by a control unit in the embodiment;

FIG. 4 is a diagram of an example of a commodity registration screen in the embodiment;

FIG. 5 is a flowchart of commodity registration processing in the embodiment;

FIG. 6 is a diagram of an example of the commodity registration screen in the embodiment;

FIG. 7 is a diagram of an example of the commodity registration screen in the embodiment;

FIG. 8 is a flowchart of cancellation processing in the embodiment;

FIG. 9 is a flowchart of settlement processing in the embodiment;

FIG. 10 is a diagram of an example of a payment screen in the embodiment;

FIG. 11 is a diagram of an example of a popup for informing realization of a price reduction in the embodiment; and

FIG. 12 is a diagram of an example of the popup for informing lapse of a price reduction in the embodiment.

### DETAILED DESCRIPTION

In general, according to one embodiment, a commodity data processing apparatus includes a control unit. The control unit includes a calculating section, a price-reduction executing section, and a price-reduction informing section. The calculating section calculates a total amount of selling prices of purchased commodities on the basis of commodity data of the purchased commodities stored in a storing section. The price-reduction executing section reduces, if the total amount exceeds a reference amount and a price reduction target commodity is included in the purchased commodities, a selling price of the target commodity. The price-reduction informing section generates screen data for informing that the price reduction is performed.

An embodiment is explained below with reference to the drawings.

In this embodiment, as a form of a commodity data processing apparatus, a POS terminal 1 used for a checkout job in a convenience store or a supermarket is explained as an example.

### Main Part Configuration

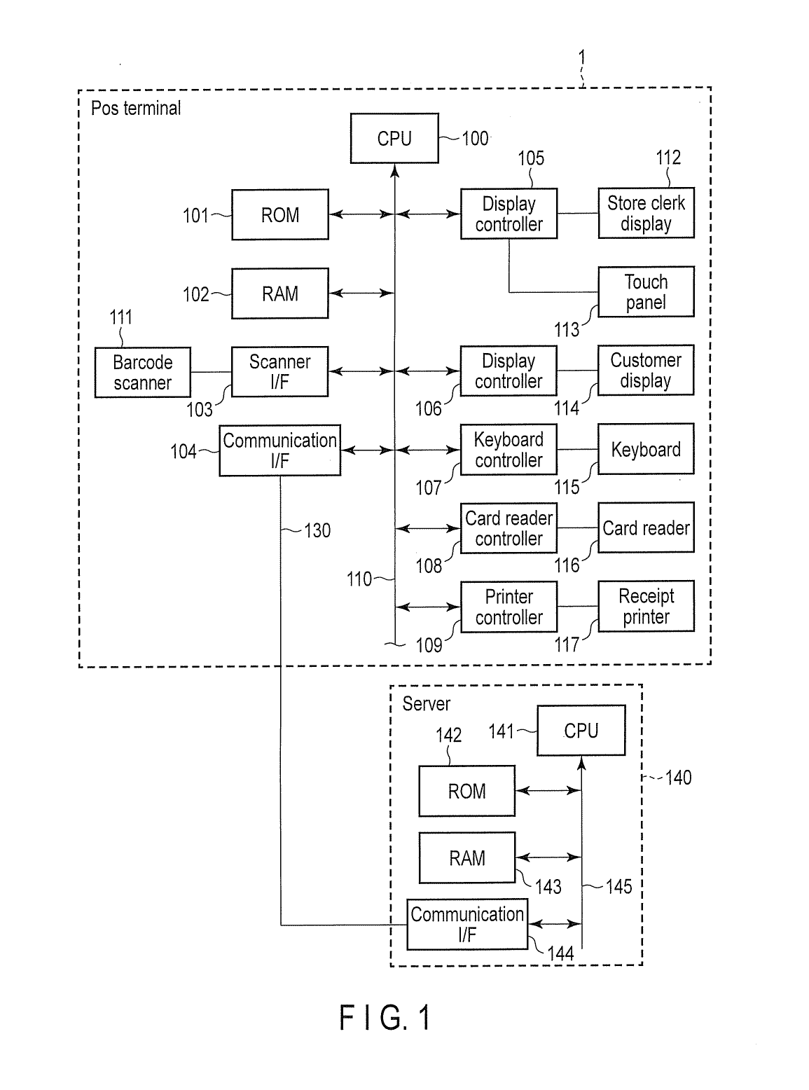

FIG. 1 is a block diagram of a main part configuration of the POS terminal 1 in this embodiment. The POS terminal 1 includes a CPU 100 functioning as the center of control.

A ROM 101, a RAM 102, a scanner I/F 103, a communication I/F 104, display controllers 105 and 106, a keyboard controller 107, a card reader controller 108, and a printer controller 109 are connected to the CPU 100 via a bus line 110. A barcode scanner 111 is connected to the scanner I/F 103. A store clerk display 112 and a touch panel 113 are connected to the display controller 105. A customer display 114 is connected to the display controller 106. A keyboard 115 is connected to the keyboard controller 107. A card reader 116 is connected to the card reader controller 108. A receipt printer 117 is connected to the printer controller 109.

The ROM 101 has stored therein fixed data such as a control program for the POS terminal 1. The control program includes a computer program for causing a computer, i.e., the POS terminal 1 in this embodiment to process commodity data. The control program may be provided while being stored in, other than the ROM 101, a computer readable non-transitory storage medium such as a CD-ROM. The control program may be downloaded to the POS terminal 1 via a network such as the Internet.

The RAM 102 functions as a main memory of the POS terminal 1 and temporarily stores various data. The control program stored in the ROM 101 is read out to the RAM 102 and executed by the CPU 100. When the control program is provided by a computer readable storage medium such as a CD-ROM, the control program is read out from the storage medium to the RAM 102 and executed by the CPU 100.

The barcode scanner 111 is, for example, a handy-type scanner that an operator holds and operates. The barcode scanner 111 optically reads a barcode affixed to a commodity and decodes the barcode into a commodity code. The scanner I/F 103 captures the commodity code decoded by the barcode scanner 111 and notifies the CPU 100 of the commodity code.

A LAN line 130 that communicatively connects the POS terminal 1 to a LAN (Local Area Network) of a store, where the POS terminal 1 is set, is connected to the communication I/F 104. The communication I/F 104 controls data communication with an external apparatus such as a store server performed via the LAN line 130.

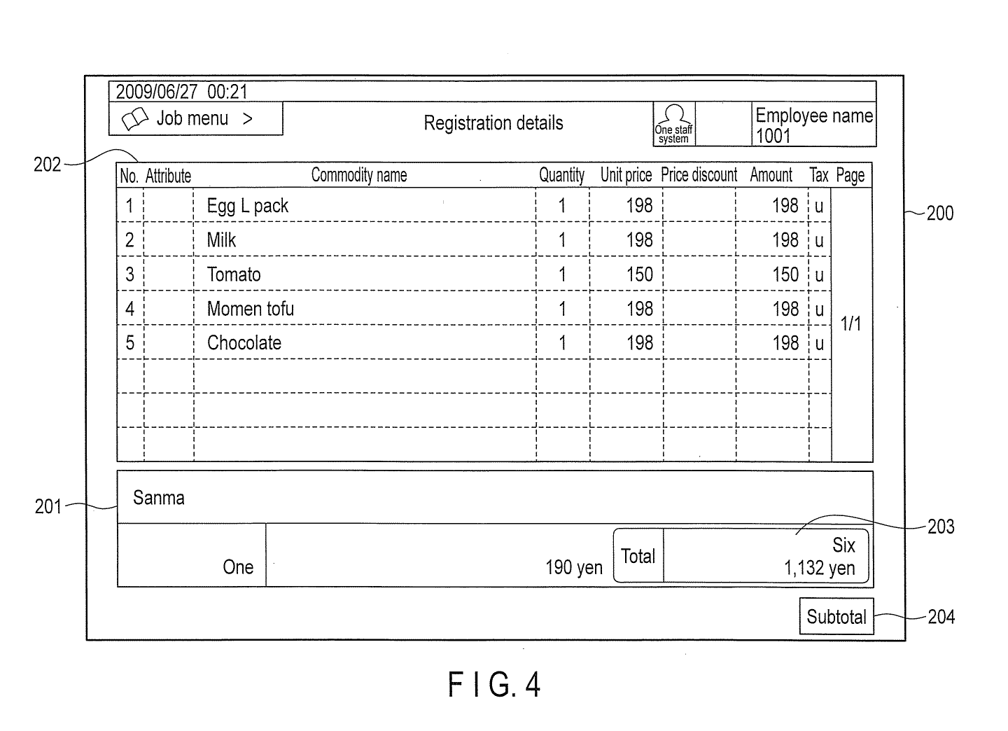

In this embodiment, as shown in FIG. 4, a server 140 is connected to the LAN circuit 130. Besides the LAN of the store, a network such as the Internet may be interposed between the POS terminal 1 and the server 140. The server 140 may be the store server or may be a server used in a cloud computing system.

The server 140 includes a CPU 141 functioning as the center of control. A ROM 142, a RAM 143, and a communication I/F 144 are connected to the CPU 141 via a bus line 145. The ROM 142 has stored therein fixed data such as a control program for the server 140. The RAM 143 functions as a main memory of the server 140 and temporarily stores various data. The LAN line 130 is connected to the communication I/F 144. The communication I/F 144 controls data communication with the POS terminal 1 performed via the LAN line 130.

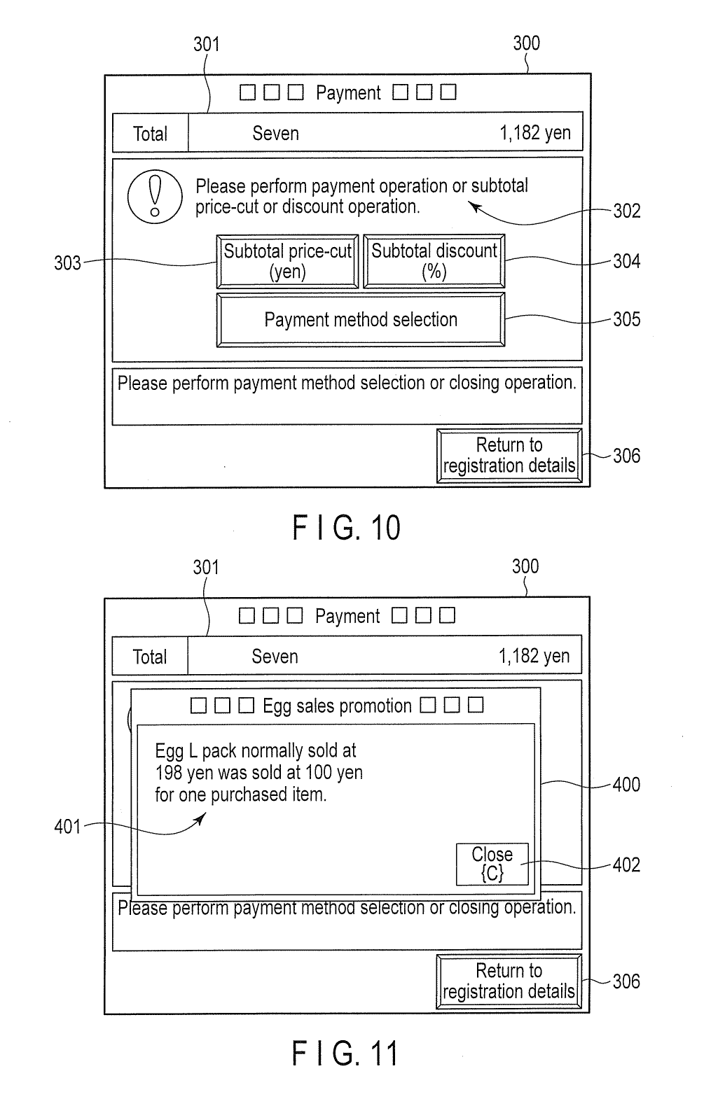

The store clerk display 112 is, for example, an LCD (Liquid Crystal Display) and displays a commodity registration screen 200 (see FIGS. 4, 6, and 7), a payment screen 300 (see FIG. 10), a screen for various kinds of setting, and the like. The touch panel 113 is provided on a display surface of the store clerk display 112 and outputs a signal corresponding to a position touched by a finger of an operator or a touch pen. The display controller 105 controls screen display of the store clerk display 112 according to a command from the CPU 100, monitors operation of GUIs displayed on the store clerk display 112 on the basis of a signal output from the touch panel 113, and, if any one of GUIs is operated, notifies the CPU 100 to that effect.

The customer display 114 is, for example, a VFD (Vacuum Fluorescent Display) and selectively displays a name and a price of a commodity subjected to sales registration, a total amount of a transaction, a change amount, and the like. The display controller 106 controls the customer display 114 according to a command from the CPU 100.

The keyboard 115 is a mechanical keyboard including a PLU (Price Look Up) key, a deposit and cash total key, a cancellation key, number keys, and the like and outputs a signal corresponding to a pressed operation key. The keyboard controller 107 captures a signal output from the keyboard 115 and notifies the CPU 100 of the signal.

The card reader 116 is a card reader of an IC type or a magnetic type configured to read card information from a credit card, a debit card, a point card of the store, or the like. The card reader controller 108 captures the card information read by the card reader 116 and notifies the CPU 100 of the card information.

The receipt printer 117 issues a receipt on which details of a transaction and the like are printed. The printer controller 109 drives the receipt printer 117 according to a command from the CPU 100 and causes the receipt printer 117 to issue the receipt.

### Memory Configuration

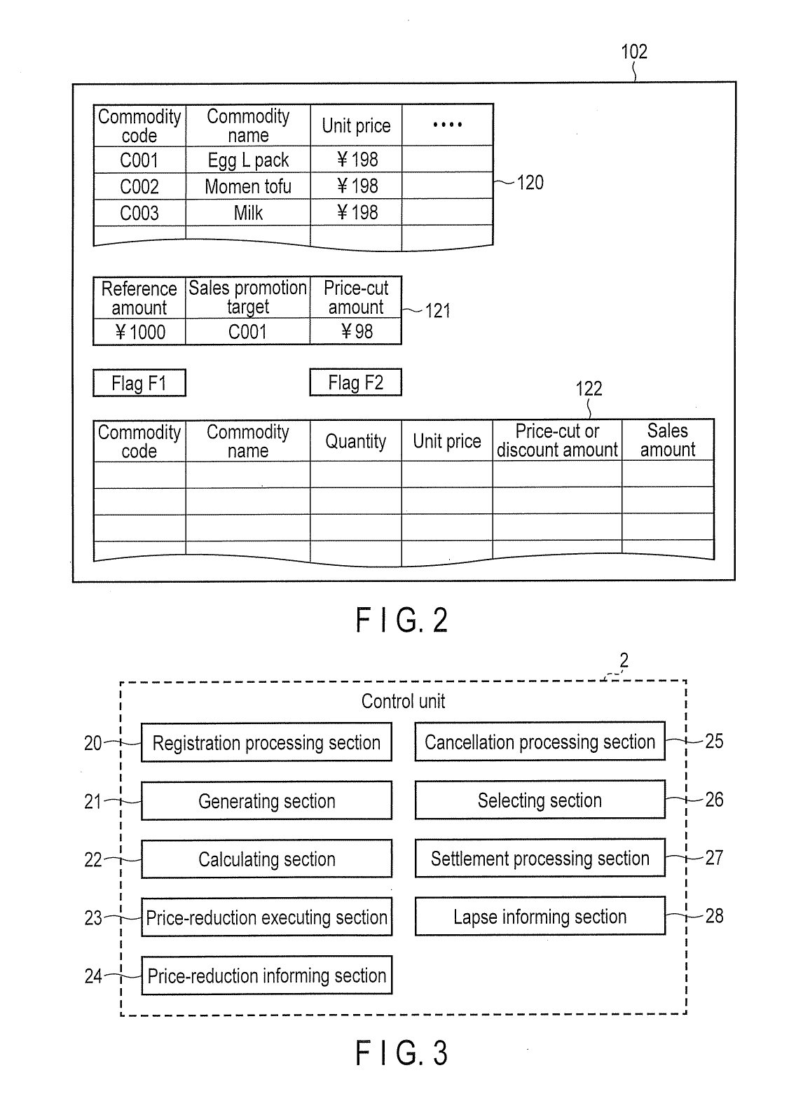

FIG. 2 is a memory configuration diagram of the RAM 102. A commodity master 120 and a sales promotion information file 121 distributed from the store server are stored in the RAM 102. For example, when commodity registration processing explained later is performed, flags F1 and F2 and a sales registration buffer 122 are formed.

The commodity master 120 includes records provided for respective commodities sold in the store. In the records, commodity codes, commodity names, unit prices, and the like of the commodities corresponding to the records are respectively described. For example, in a record of a commodity code “C001” shown in the figure, a commodity name “egg L pack”, a unit price “198 yen”, and the like are described.

The sales promotion information file 121 is a file indicating price reduction conditions and a price-cut amount. In an example shown in the figure, a reference amount “1000 yen” and the commodity code “C001” of a sales promotion target commodity are described as the price reduction conditions and “98 yen” is described as the price-cut amount. This means that, if a total price of commodities other than the sales promotion target subjected to sales registration exceeds the reference amount “1000 yen” and the commodity having the commodity code “C001”, i.e., “egg L pack” is included in the commodities subjected to the sales registration, the price of the commodity is cut by the price-cut amount “98 yen”.

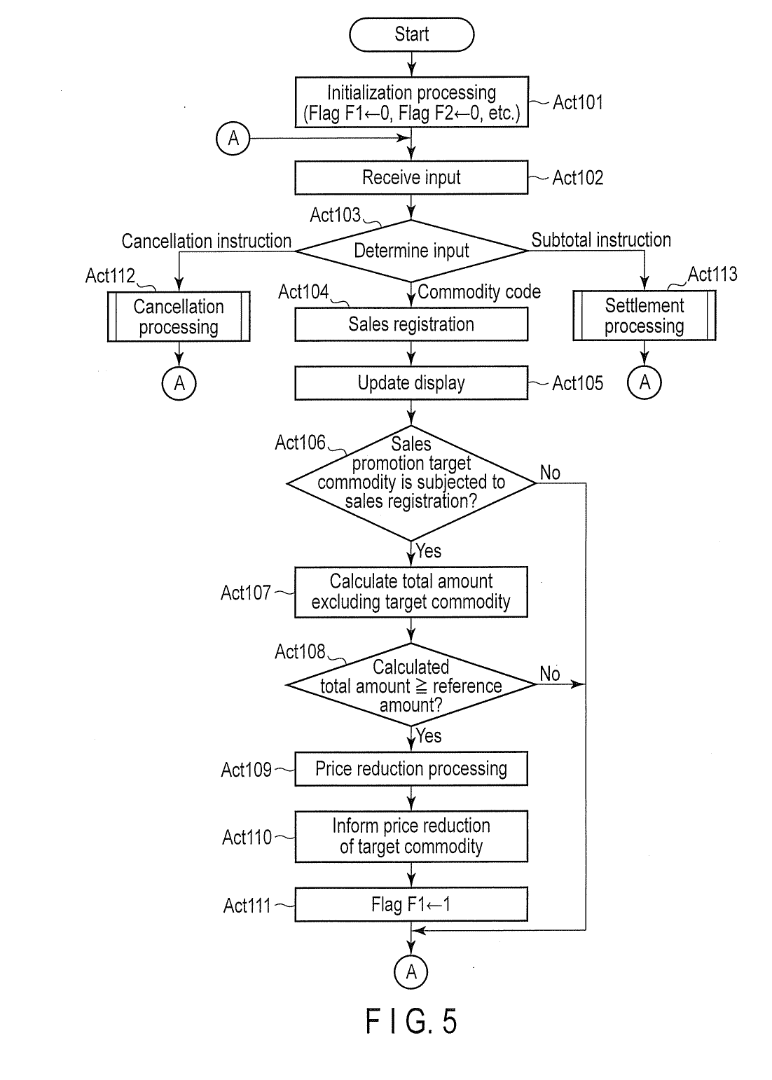

“0” or “1” is set in the flags F1 and F2. Specific roles of the flags F1 and F2 are explained later with reference to FIGS. 5 to 12.

The sales registration buffer 122 is an area for storing commodity data of a commodity, a commodity code of which is input by the barcode scanner 111 or the like. The sales registration buffer 122 includes records including a commodity code, a commodity name, a quantity of purchase, a unit price, a price-cut or discount amount from the unit price, and a sales amount obtained by multiplying, with the quantity, an amount obtained by subtracting the price-cut or discount amount from the unit price. The records may be provided in a state of blanks from the beginning of commodity registration processing or may be formed every time commodity data is registered.

### Control Unit

A control unit including the CPU 100, the ROM 101, and the RAM 102 of the POS terminal 1 is explained below.

FIG. 3 is a block diagram of functions realized by a control unit 2 in this embodiment. As shown in the figure, the control unit 2 includes a registration processing section 20, a generating section 21, a calculating section 22, a price-reduction executing section 23, a price-reduction informing section 24, a cancellation processing section 25, a selecting section 26, a settlement processing section 27, and a lapse informing section 28. The sections 20 to 28 are realized by the CPU 100 executing the control program.

The registration processing section 20 executes various kinds of processing related to commodity registration processing explained later.

The generating section 21 generates screen data in which commodity data stored in the sales registration buffer 122 are arranged.

The calculating section 22 calculates, on the basis of the commodity data stored in the sales registration buffer 122, a total amount of selling prices of commodities purchased by a customer.

If the total amount calculated by the calculating section 22 exceeds a reference amount set in advance and a price reduction target commodity set in advance is included in the commodities to be purchased, the price-reduction executing section 23 reduces a selling price of the target commodity.

The price-reduction informing section 24 generates screen data for informing that a price reduction by the price-reduction executing section 23 is performed.

The cancellation processing section 25 executes various kinds of processing related to cancellation processing explained later. In particular, in this embodiment, if a commodity to be cancelled is designated from commodities corresponding to the commodity data stored in the sales registration buffer 122, the cancellation processing section 25 deletes commodity data of the commodity from the sales registration buffer 122.

If the commodity to be cancelled is designated from the commodities corresponding to the commodity data stored in the sales registration buffer 122 and if a price reduction by the price-reduction executing section 23 is unrealized by deleting commodity data of the commodity from the sales registration buffer 122, the selecting section 26 generates screen data for causing the operator to select whether the cancellation is executed.

The settlement processing section 27 executes various kinds of processing related to settlement processing explained later.

After the screen data for informing that the price reduction is performed is generated by the price-reduction informing section 24, if the price reduction by the price-reduction executing section 23 is unrealized because the commodity data stored in the sales registration buffer 122 is deleted by the cancellation processing section 25, the lapse informing section 28 generates screen data for informing the lapse of the price reduction.

If the screen data are generated by the generating section 21, the price-reduction informing section 24, the selecting section 26, the lapse informing section 28, and the like, the display controller 105 causes the store clerk display 112 to display screens based on the screen data.

The control unit 2 may include the CPU 141, the ROM 142, and the RAM 143 of the server 140. In this case, the sections 20 to 28 are realized by, for example, the CPU 141 executing the control program stored in the ROM 142 or the storage medium such as the CD-ROM. In this case, a browser for viewing the screen data generated by the generating section 21, the price-reduction informing section 24, the selecting section 26, the lapse informing section 28, and the like only has to be installed in the POS terminal 1 to display the screens based on the screen data on the store clerk display 112 via the browser.

The operations of the POS terminal 1 are explained below.

### Commodity Registration Processing

If the POS terminal 1 is set in a checkout job mode according to operation of a not-shown mode switch, the commodity registration screen 200 shown in FIG. 4 is displayed on the store clerk display 112. The screen 200 is displayed on the basis of the screen data generated by the generating section 21. The screen 200 includes a current area 201 in which commodity data of the sales registration buffer 122 are arranged, a registration detail area 202, a total area 203, and a subtotal button 204 (subtotal indicating unit). In the current area 201, a commodity name, a quantity, and a sales amount included in latest commodity data stored in the sales registration buffer 122 are displayed in the current area 201. In the registration detail area 202, commodity names, quantities, unit prices, price-cut or discount amounts (“price-cut or discount” in the figure), sales amounts (“amount” in the figure), and the like included in the commodity data stored in the sales registration buffer 122 excluding the latest commodity data are displayed in order of sales registration with numbers in the ascending order affixed thereto from “1”. In the total area 203, a total number of commodities subjected to sales registration and a total amount are displayed. The subtotal button 204 is a button for inputting a subtotal instruction for selling prices of the commodities subjected to the sales registration and is a GUI that can be operated by a touch on a display position. An example shown in the figure indicates a state in which several commodities are already subjected to the sales registration. However, at the beginning of the sales registration processing, commodity data, total number of items, and total amounts are not displayed in the current area 201, the registration detail area 202, and the total area 203.

If the PLU key of the keyboard 115 is operated in a state in which such a commodity registration screen 200 is displayed, the commodity registration processing is started. A flowchart of the processing is shown in FIG. 5.

At the beginning of the start of the commodity registration processing, first, the registration processing section 20 executes initialization processing for the flags F1 and F2 and the sales registration buffer 122 (ACT 101). The flags F1 and F2 are reset to “0” and the data of the sales registration buffer 122 is cleared through the initialization processing.

Subsequently, the registration processing section 20 receives input of a commodity code by reading of a barcode by the barcode scanner 111 or operation of a preset key displayed on the store clerk display 112 and input of various instructions by operation of the store clerk display 112 and the keyboard 115 (ACT 102). If there is some input to the registration processing section 20, the registration processing section 20 determines a type of the input (ACT 103).

If the type of the input is input of a commodity code (“commodity code” in ACT 103), the registration processing section 20 subjects a commodity corresponding to the input commodity code to sales registration (ACT 104). Specifically, the registration processing section 20 reads out a commodity name and a unit price corresponding to the input commodity code from the commodity master 120 and describes the commodity name and the unit price in vacant records of the sales registration buffer 122. If a quantity is not designated by the operator, the registration processing section 20 sets a quantity of the record to “1”. If a quantity is designated, the registration processing section 20 sets the quantity of the record to the designated number. The registration processing section 20 sets a price-cut amount of the record to “0”, calculates a sales amount, and describes the sales amount in the record.

After subjecting the commodity to the sales registration in this way, the calculating section 22 calculates, on the basis of the quantity and the sales amount described in the records of the sales registration buffer 122, a total number of items and a total amount of the commodity to be purchased. The generating section 21 generates screen data on the basis of the total number of items and the total amount calculated by the calculating section 22 and the commodity data stored in the present sales registration buffer 122 (ACT 105).

The screen data generated by the processing in ACT 105 shows the commodity registration screen 200 on which the total number of items and the total amount calculated by the calculating section 22 are arranged in the total area 203, the latest commodity data (the commodity name, the quantity, and the unit price) stored in the sales registration buffer 122 in ACT 104 is arranged in the current area 201, and the commodity data (commodity names, quantities, unit prices, price-cut or discount amounts, and sales amounts) stored in the sales registration buffer 122 excluding the latest commodity data is arranged in the registration detail area 202.

A screen based on the screen data generated in the processing in ACT 105 is displayed on the store clerk display 112. In this way, every time commodity data is stored in the sales registration buffer 122, the sales registration screen 200 displayed on the store clerk display 112 is updated.

The price-reduction executing section 23 determines whether the commodity designated as the sales promotion target in the sales promotion information file 121 is subjected to sales registration (ACT 106). If a record having the commodity code “C001” of the sales promotion target is not stored in the sales registration buffer 122, the price-reduction executing section 23 determines that the commodity of the sales promotion target is not subjected to the sales registration (No in Act 106). In this case, the processing returns to ACT 102 and the processing in ACT 102 and subsequent acts is executed again.

On the other hand, if a record having the commodity code “C001” is stored in the sales registration buffer 122, the price-reduction executing section 23 determines that the sales promotion target commodity is subjected to the sales registration (Yes in ACT 106). In this case, the calculating section 22 calculates, on the basis of the sales amounts of the records of the sales registration buffer 122, a total amount excluding a sales amount of the sales promotion target commodity (ACT 107). The price-reduction executing section 23 determines whether the total amount calculated by the calculating section 22 is the same as or exceeds the reference amount “1000 yen” of the sales promotion information file 121 (ACT 108). As a result, if the total amount is smaller than the reference amount (No in ACT 108), the processing returns to ACT 102 and the processing in ACT 102 and subsequent acts is executed again.

On the other hand, if the total amount is the same as or exceeds the reference amount (Yes in ACT 108), the price-reduction executing section 23 executes price reduction processing for the sales promotion target commodity (ACT 109). In this processing, the price-reduction executing section 23 describes the price-cut amount “98 yen” of the sales promotion information file 121 in a price-cut or discount amount of a record corresponding to the sales promotion target commodity of the sales registration buffer 122 and calculates a sales amount of the record again. In this way, a selling price of the sales promotion target commodity is reduced.

After the price reduction processing, the price-reduction informing section 24 generates screen data for informing that the price reduction by the price-reduction executing section 23 is performed (ACT 110). A screen based on the screen data is displayed on the store clerk display 112.

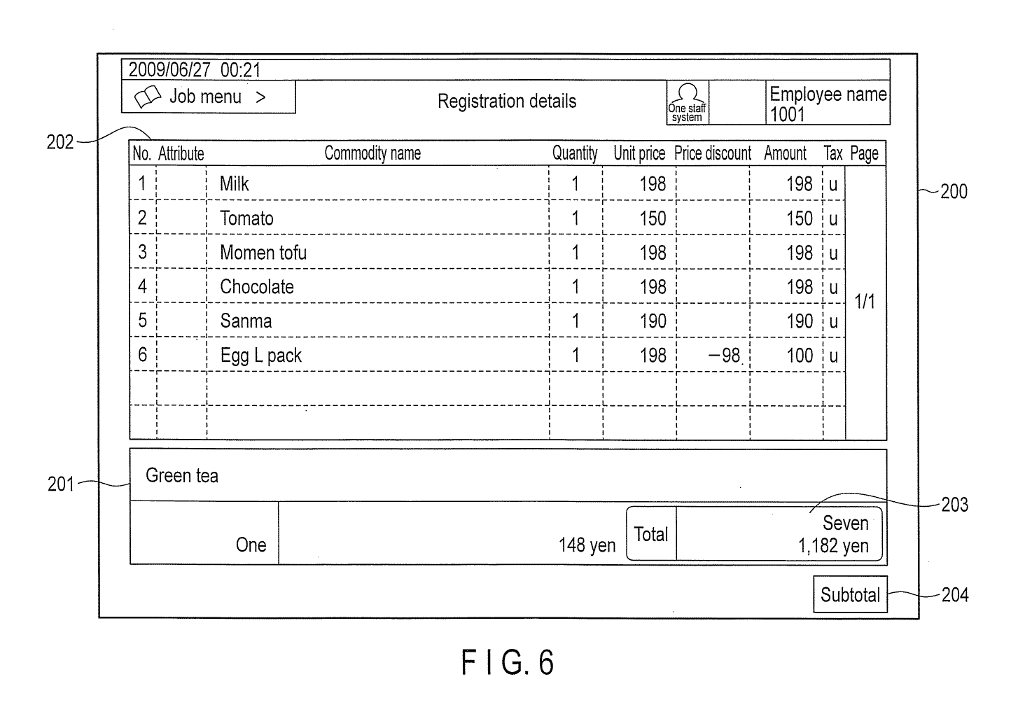

In ACT 110, the price-reduction informing section 24 generates screen data of the sales registration screen 200 in which the display order of the commodity data is changed from that in the sales registration screen 200 currently displayed on the store clerk display 112 such that, for example, commodity data of the sales promotion target commodity is located at the end of the registration detail area 202. This example is explained with reference to FIGS. 4 and 6. In the state shown in FIG. 4, if “green tea” having a unit price “148 yen” is subjected to sales registration as a commodity to be purchased, a total amount excluding “egg L pack”, which is the sales promotion target commodity, exceeds the reference amount “1000 yen”. In this case, the price-reduction informing section 24 generates screen data of the sales registration screen 200 in which commodity data of “egg L pack” originally displayed in the position of the number “1” is shifted to the position of the number “6” at the end, other commodity data are rearranged in order from the top, and a price-cut or discount amount of “egg L pack” is set to “−98 yen” and a sale price of “egg L pack” is set to “100 yen”.

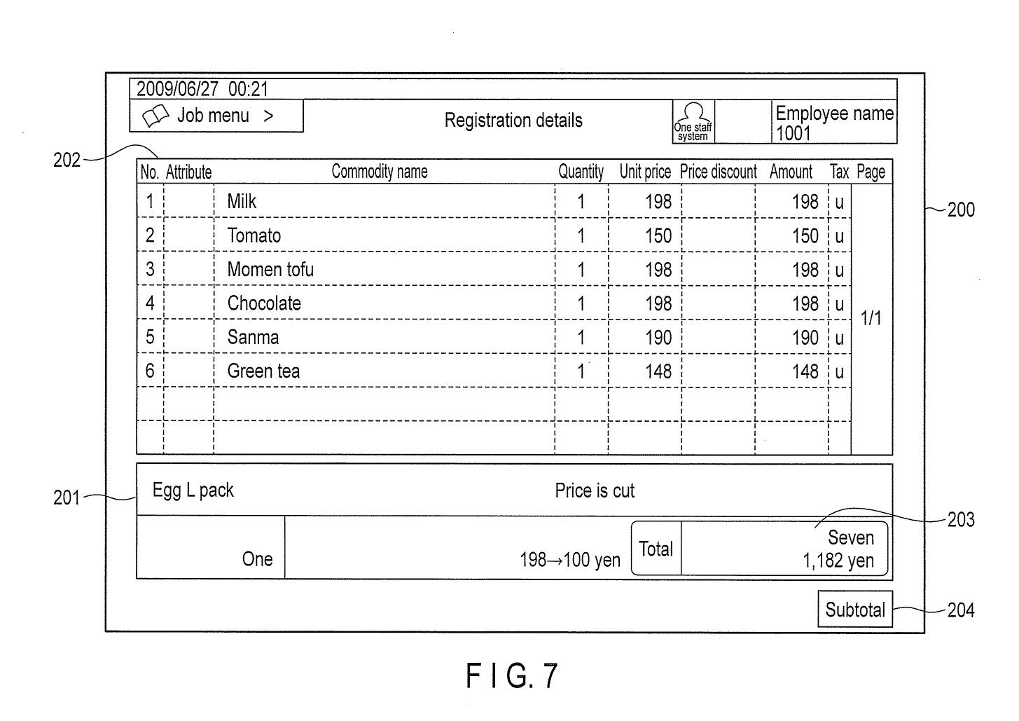

In ACT 110, the price-reduction informing section 24 may generate, for example, screen data of the sales registration screen 200 in which the commodity data of the sales promotion target commodity is arranged in the current area 201. This example is explained with reference to FIGS. 4 and 7. In the state shown in FIG. 4, if “green tea” having a unit price “148 yen” is registered as a commodity to be purchased, a total amount excluding “egg L pack”, which is the sales promotion target commodity, exceeds the reference amount “1000 yen”. In this case, the price-reduction informing section 24 generates screen data of the sales registration screen 200 in which the commodity data of “egg L pack” originally displayed in the position of the number “1” is shifted to the current area 201 and the other commodity data arranged in the registration detail area 202 are rearranged in order from the top. Further, on this screen 200, a message such as “price is cut” may be arranged in the current area 201 to indicate that the price of “egg L pack” is reduced from “198 yen” to “100 yen”.

After the processing in ACT 110, the registration processing section 20 sets the flag F1 to “1” (ACT 111). Thereafter, the processing returns to ACT 102 and the processing in ACT 102 and subsequent acts is executed again.

### Cancellation Processing

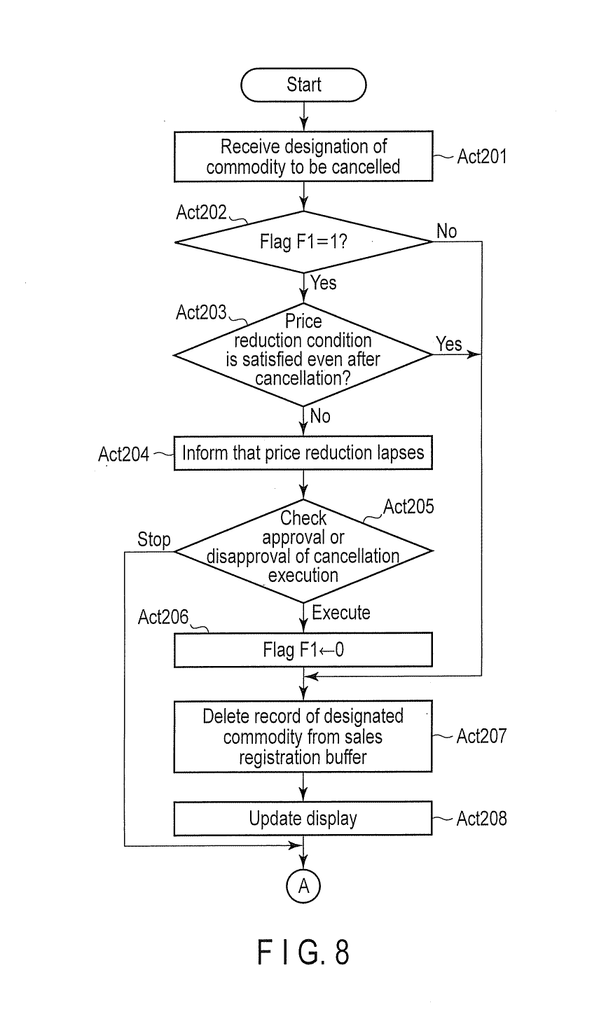

If the input received in ACT 102 of the commodity registration processing is input of a cancellation instruction by the operation of the cancellation key of the keyboard 115 (“cancellation instruction” in ACT 103), cancellation processing is executed (ACT 112). A flowchart of this processing is shown in FIG. 8.

At the beginning of the start of the cancellation processing, first, the cancellation processing section 25 receives designation of a commodity to be cancelled (ACT 201). If a cancellation target commodity is designated by touch operation on the store clerk display 112 or the operation of the keyboard 115, the cancellation processing section 25 determines whether the flag F1 is set to “1” (ACT 202). If the flag F1 is set to “1” (Yes in ACT 202), the price reduction processing in ACT 109 is already performed. In this case, the cancellation processing section 25 determines whether the price reduction condition of the sales promotion information file 121 is satisfied even after sales registration for the cancellation target commodity designated in ACT 201 is cancelled (ACT 203).

In ACT 203, if a total amount of the commodities excluding the sales promotion target commodity is smaller than the reference amount after the cancellation or the sales promotion target commodity itself is designated as a cancellation target, the cancellation processing section 25 determines that the price reduction condition is not satisfied after the cancellation (No in ACT 203). In this case, the cancellation processing section 25 generates screen data for informing that the price reduction lapses according to the execution of the cancellation (ACT 204). The screen data includes, for example, a message indicating that the price reduction lapses according to the execution of the cancellation. A screen based on the screen data generated in ACT 204 is displayed on the store clerk display 112 and the customer display 114.

After ACT 204, the selecting section 26 generates screen data for causing the operator to select whether the cancellation of the commodity designated as the cancellation target is executed (ACT 205). A screen based on the screen data generated in ACT 204 is displayed on, for example, the store clerk display 112. This screen includes, for example, an execution button for approving the execution of the cancellation and a stop button for stopping the cancellation. The selecting section 26 confirms approval or disapproval of the cancellation execution with the operator through these buttons.

If the operator touch-operates the stop button (“stop” in ACT 205), the processing returns to ACT 102 and the processing in ACT 102 and subsequent acts is executed again.

On the other hand, if the operator touch-operates the execution button (“execute” in ACT 205), the cancellation processing section 25 sets the flag F1 to “0” (ACT 206). The cancellation processing section 25 deletes a record of the cancellation target commodity designated in ACT 201 from the sales registration buffer 122 and decides the cancellation (ACT 207).

After ACT 207, the calculating section 22 calculates, on the basis of quantities and sales amounts described in the records of the sales registration buffer 122 after the commodity data of the cancellation target commodity is deleted, a total number of items and a total amount of the commodity to be purchased. The generating section 21 generates screen data on the basis of the total number of items and the total amount calculated by the calculating section 22 and the commodity data stored in the present sales registration buffer 122 (ACT 208).

A screen based on the screen data generated in ACT 208 is displayed on the store clerk display 112. Thereafter, the processing returns to ACT 102 and the processing in ACT 102 and subsequent acts is executed again.

If the cancellation processing section 25 determines in ACT 202 that the flag F1 is not set to “1” (No in ACT 202) and if the cancellation processing section 25 determines in ACT 203 that the price reduction condition is satisfied even after the cancellation (Yes in ACT 203), the processing in ACTS 207 and 208 is executed. Thereafter, the processing returns to ACT 102 and the processing in ACT 102 and subsequent acts is executed again.

### Settlement Processing

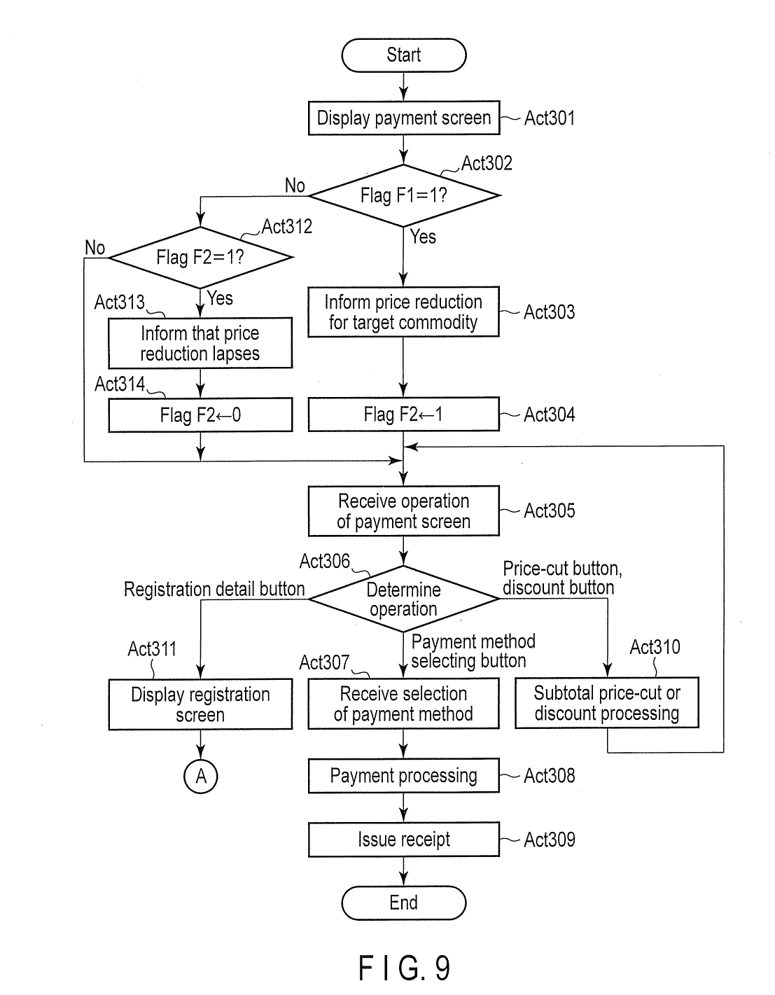

If the input received in ACT 102 of the commodity registration processing is input of a subtotal instruction by the operation of the subtotal button 204 (“subtotal instruction” in ACT 103), settlement processing is executed (ACT 113). A flowchart of this processing is shown in FIG. 9.

At the beginning of the start of the settlement processing, first, the settlement processing section 27 generates screen data of the payment screen 300 shown in FIG. 10 (ACT 301). The payment screen 300 based on the screen data generated in ACT 301 is displayed on the store clerk display 112.

The payment screen 300 is displayed if the subtotal button 204 is touch-operated in the state of the commodity registration screen 200 shown in FIG. 6 and the like. The payment screen 300 includes a total area 301 in which a total number of items and a subtotal amount of a commodity subjected to sales registration are displayed, a message 302 for urging payment operation and subtotal price discount operation, a subtotal price-cut button 303 for instructing execution of a subtotal price-cut, a subtotal discount button 304 for instructing execution of a subtotal discount, a payment method selection button 305 for instructing selection of a payment method, and a registration detail button 306 for instructing redisplay of the commodity registration screen 200. The buttons 303 to 306 are GUIs that can be operated by a touch on display positions.

After such a payment screen 300 is displayed, the settlement processing section 27 determines whether the flag F1 is set to “1” (ACT 302). If the flag F1 is set to “1” (Yes in ACT 302), the price reduction processing in ACT 109 is already performed. In this case, the price-reduction informing section 24 generates screen data for informing that the price of the sales promotion target commodity is reduced (ACT 303). A screen based on the screen data generated in ACT 303 is displayed on the store clerk display 112. The settlement processing section 27 sets the flag F2 to “1”, which indicates that the price reduction is already informed (Act 304).

The screen data generated in ACT 303 is, for example, screen data representing a popup 400 shown in FIG. 11. The popup 400 is displayed on, for example, the payment screen 300. The popup 400 includes a message 401 indicating that the price of the sales promotion target commodity indicated by the sales promotion information file 121 is reduced by the price-cut amount indicated by the file 121 and a close button 402 for closing the popup 400. The close button 402 is a GUI that can be operated by a touch on a display position.

If the close button 402 is touch-operated, the settlement processing section 27 closes the popup 400 and receives operation on the buttons 303 to 306 of the payment screen 300 (ACT 305). If any one of the buttons is touch-operated, the settlement processing section 27 determines a type of the operated button (ACT 306). If the operated button is the payment method selection button 305 (“payment method selection button” in ACT 306), the settlement processing section 27 generates, for example, screen data including a GUI for selecting any one of cash payment, credit card payment, and electronic money payment on the store clerk display 112 (ACT 307).

A screen based on the screen data generated in ACT 307 is displayed on the store clerk display 112 and selection of a payment method for a price is received. If the operator selects a payment method via the screen, the settlement processing section 27 executes payment processing by the selected payment method (ACT 308). For example, if the cash payment is selected, the settlement processing section 27 receives input of a deposit amount, deducts a subtotal amount in the total area 301 from the input amount to calculate change, and causes the store clerk display 112 and the customer display 114 to display the change. If the credit card payment is selected, the settlement processing section 27 receives reading of a credit card by the card reader 116, accesses a management server of a credit card company on the basis of read credit card information, and performs card settlement. If the electronic money payment is selected, the settlement processing section 27 debits the subtotal amount of the total area 301 from an electronic money medium held over a not-shown electronic money interface.

If the payment processing is completed by any one of the methods, the settlement processing section 27 causes the receipt printer 117 to issue a receipt on which detail information of the transaction is printed and a credit slip (ACT 309). After ACT 309, the settlement processing ends.

On the other hand, if the operation received in

ACT 305 is the operation of the subtotal price-cut button 303 or the subtotal discount button 304 (“price-cut button, discount button” in ACT 306), the settlement processing section 27 executes price discount processing for the subtotal amount (ACT 310). In this processing, for example, if the subtotal price-cut button 303 is operated, the settlement processing section 27 receives input of a price-cut amount by the operation of the keyboard 115 and updates the subtotal amount of the total area 301 with an amount obtained by deducting the price-cut amount from the present subtotal amount. If the subtotal discount button 304 is operated, the settlement processing section 27 receives input of a discount rate by the operation of the keyboard 115 and updates the subtotal amount of the total area 301 with an amount obtained by reducing the present subtotal amount according to the discount rate. After the price discount processing for the subtotal amount is executed in this way, the processing returns to ACT 305 and the processing in ACT 305 and subsequent acts is executed again.

On the other hand, if the operation received in

ACT 305 is the operation of the registration detail button 306 (“registration detail button” in ACT 306), the settlement processing section 27 deletes the payment screen 300 from the store clerk display 112 and causes the store clerk display 112 to display the commodity registration screen 200 (ACT 311). Thereafter, the processing returns to ACT 102 in the commodity registration processing and the processing in ACT 102 and subsequent acts is executed again.

If the flag F1 is not set to “1” in ACT 302 (No in ACT 302), the settlement processing section 27 determines whether the flag F2 is set to “1” (ACT 312).

After the price reduction for the sales promotion target commodity is informed by the popup 400 (ACT 303), the registration detail button 306 is operated and the commodity registration screen 200 is redisplayed (ACT 311) and the subtotal button 204 is re-operated and the payment screen 300 is displayed (ACT 301). Moreover, if the flag F1 is set to “0” because the price reduction condition is unsatisfied by the cancellation processing (ACT 206), the flag F1 is set to “0” and the flag F2 is set to “1” (No in ACT 302 and Yes in ACT 312). In this case, the lapse informing section 28 generates screen data for informing the lapse of the price reduction (ACT 313). A screen based on the screen data generated in ACT 313 is displayed on the store clerk display 112. The lapse informing section 28 sets the flag F2 to “0” (ACT 314).

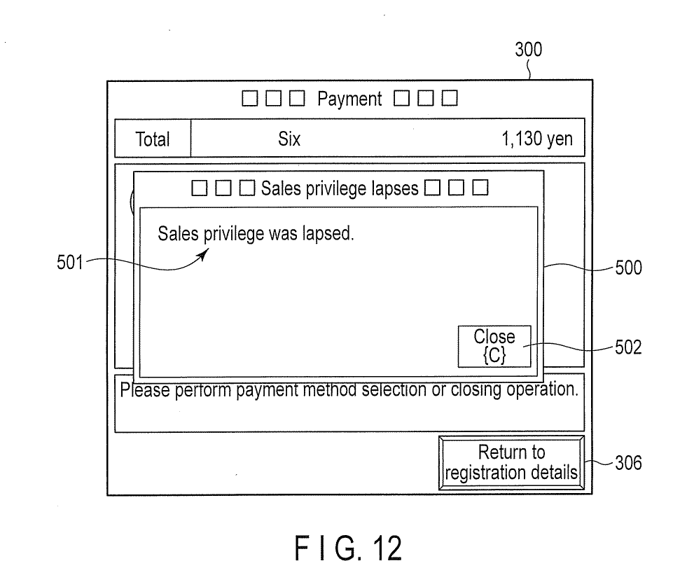

The screen data generated in ACT 313 is, for example, screen data representing a popup 500 shown in FIG. 12. The popup 500 shown in the figure is displayed if “tomato” is cancelled in the state in which the commodities are subjected to sales registration as shown in FIG. 6 and the price reduction lapses. The popup 500 includes a message 501 indicating that the price reduction indicated by the sales promotion information file 121 lapses and a close button 502 for closing the popup 500. The close button 502 is a GUI that can be operated by a touch on a display position.

If the close button 502 is touch-operated, the settlement processing section 27 closes the popup 500 and receives operation on the buttons 303 to 306 of the payment screen 300 (ACT 305). Thereafter, the processing in ACT 305 and subsequent acts is executed.

The above is a series of explanation concerning the operations in this embodiment.

As explained above, in this embodiment, a price reduction of a selling price of a target commodity is performed if a total amount of commodities subjected to sales registration exceeds the reference amount (ACT 109). If the price reduction is performed, the operator of the POS terminal 1 is informed to that effect (ACT 110 and ACT 303). Therefore, the operator can easily grasp that the price reduction is realized.

In particular, in ACT 110, the realization of the price reduction is informed by changing an arrangement position of the commodity data of the sales promotion target commodity displayed on the registration screen 200. Therefore, even during commodity registration, the operator can learn, simply by looking at the commodity registration screen 200, that the price of the sales promotion target commodity is reduced.

In ACT 303, if a subtotal instruction is input in a state in which the price of the sales promotion target commodity is reduced, the realization of the price reduction is informed by the popup 400. Therefore, even if the operator does not notice the information in ACT 110, if the subtotal instruction is input, the operator can surely learn that the price of the sales promotion target commodity is reduced.

In this embodiment, after the price reduction for the sales promotion target commodity is informed by the popup 400 (ACT 303), the sales registration for the commodity is cancelled by the cancellation processing (ACT 112). As a result, if the price reduction lapses, the lapse of the price reduction is informed by the popup 500 (ACT 313). Therefore, the operator can surely learn not only the price reduction but also the lapse of the price reduction.

In this embodiment, if a cancellation target commodity is designated in the cancellation processing after the price of the sales promotion target commodity is reduced (ACT 201), if the price reduction lapses because of the cancellation of the commodity, the lapse of the price reduction is informed (ACT 204) and approval or disapproval of the cancellation execution is confirmed with operator (ACT 205). With such a configuration, for example, the operator informs the customer that the price reduction lapses if the customer cancels the commodity. This makes it possible to prevent the customer from cancelling the commodity and urge the customer to purchase a commodity instead of the commodity.

### Modifications

The configuration disclosed in the embodiment can be embodies by modifying the components as appropriate at an implementation stage. Specific modifications are, for example, as explained below.
(1) In the embodiment, the POS terminal of the type operated by a store clerk is explained as an example of a form of the commodity data processing apparatus. However, the same configuration as the embodiment may be applied to, for example, an ECR or a POS terminal of a self-checkout type or a card settlement terminal specialized for settlement by a credit card or the like.
(2) In the example explained in the embodiment, one target commodity is set in the sales promotion information file 121 and a selling price of the target commodity is reduced by a price-cut if a price reduction condition is satisfied. However, the selling price of the target commodity may be reduced by a discount if the price reduction condition is satisfied or plural target commodities may be set and selling prices may be reduced concerning all of the plural target commodities if the price reduction condition is satisfied.
(3) In the example explained in the embodiment, the display position of the commodity data of the commodity, the selling price of which is reduced if the price reduction condition is satisfied, is changed to the end (the bottom) of the registration detail area 202 or to the current area 201. However, the display position of the commodity data of the commodity, the selling price of which is reduced, may be changed to other positions such as the head (the top) of the registration detail area 202.
(4) In the example explained in the embodiment, the popups 400 and 500 are displayed on the store clerk display 112 and the price reduction of the sales promotion target commodity and the lapse of the price reduction are informed. However, the price reduction of the sales promotion target commodity and the lapse of the price reduction may be informed by message display on the customer display 114 or sound output from a speaker.
(5) In the example explained in the embodiment, yen is used as a currency unit of a selling price of a commodity. However, at an implementation stage, the descriptions corresponding to yen only have to be changed to an appropriate currency unit corresponding to a country or a region where the POS terminal 1 is used such as US dollar, Euro, or Chinese Yuan.
(6) In the embodiment, the control unit 2 includes the CPU 100, the ROM 101, and the RAM 102 of the POS terminal 1 or the CPU 141, the ROM 142, and the RAM 143 of the server 140. However, the control unit 2 may include hardware resources included in another apparatus communicatively connected to the POS terminal 1 and the server 140. The control unit 2 may include hardware resources included in plural apparatuses.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity data processing apparatus comprising a control unit configured to control an operation of the commodity data processing apparatus, wherein
the control unit includes:
a calculating section configured to calculate a total amount of selling prices of purchased commodities on the basis of commodity data of the purchased commodities stored in a predetermined storing section;
a price-reduction executing section configured to reduce, if the total amount calculated by the calculating section exceeds a reference amount set in advance and a price reduction target commodity set in advance is included in the purchased commodities, a selling price of the target commodity; and
a price-reduction informing section configured to generate screen data for informing that the price reduction by the price-reduction executing section is performed.

2. The apparatus according to claim 1, wherein
the control unit further includes a generating section configured to generate screen data in which commodity data stored in the storing section are arranged, wherein
if the price reduction by the price-reduction executing section is performed, the price-reduction informing section generates screen data in which an arrangement position of commodity data of the target commodity is different from an arrangement position in the screen data generated by the generating section.

3. The apparatus according to claim 2, wherein
the generating section generates screen data in which the commodity data stored in the storing section are arranged in order of storage in the storing section, and
the price-reduction informing section generates screen data in which commodity data of commodities excluding the target commodity stored in the storing section are arranged in order of storage in the storing section and the commodity data of the target commodity is arranged at an end.

4. The apparatus according to claim 2, wherein
the generating section generates screen data in which commodity data excluding latest commodity data stored in the storing section are arranged in order of storage in the storing section and the latest commodity data is arranged in a predetermined area, and
the price-reduction informing section generates screen data in which commodity data of commodities excluding the target commodity stored in the storing section are arranged in order of storage in the storing section and the commodity data of the target commodity is arranged in the predetermined area.

5. The apparatus according to claim 1, wherein, if a subtotal of selling prices of commodities corresponding to commodity data stored in the storing section is instructed and the price reduction by the price-reduction executing section is performed, the price-reduction informing section generates screen data for informing that the price reduction is performed.

6. The apparatus according to claim 5, wherein the control unit further includes a cancellation processing section configured to delete, if a commodity to be cancelled is designated from the commodities corresponding to the commodity data stored in the storing section, commodity data of the commodity from the storing section.

7. The apparatus according to claim 6, wherein the control unit further includes a lapse informing section configured to generate, after the screen data for informing that the price reduction is performed is generated by the price-reduction informing section, if the price reduction by the price-reduction executing section is unrealized because the commodity data stored in the storing section is deleted by the cancellation processing section, screen data for informing a lapse of the price reduction.

8. The apparatus according to claim 7, wherein
the control unit further includes a selecting section configured to generate, if a commodity to be cancelled is designated from the commodities corresponding to the commodity data stored in the storing section and if the price reduction by the price-reduction executing section is unrealized because commodity data of the commodity is deleted from the storing section, screen data for causing an operator to select whether the cancellation is executed, and
if execution of cancellation is selected via the screen data generated by the selecting section, the cancellation processing section deletes the commodity data of the commodity designated as the cancellation target from the storing section.

9. A control method for a commodity data processing apparatus, comprising:
generating first screen data in which commodity data of purchased commodities stored in a predetermined storing section are arranged;
calculating a total amount of selling prices of the purchased commodities on the basis of the commodity data stored in the storing section;
reducing, if the calculated total amount exceeds a reference amount set in advance and a price reduction target commodity set in advance is included in the purchased commodities, a selling price of the target commodity; and
generating, if the price reduction is performed, second screen data in which an arrangement position of commodity data of the target commodity is different from an arrangement position in the first screen data.

10. A computer readable storage medium having stored therein a computer program for causing a computer to process commodity data, the computer program causing the computer to function as:
a generating section configured to generate screen data in which commodity data of purchased commodities stored in a predetermined storing section are arranged;
a calculating section configured to calculate a total amount of selling prices of the purchased commodities on the basis of the commodity data stored in the storing section;
a price-reduction executing section configured to reduce, if the total amount calculated by the calculating section exceeds a reference amount set in advance and a price reduction target commodity set in advance is included in the purchased commodities, a selling price of the target commodity; and
a price-reduction informing section configured to generate, if the price reduction by the price-reduction executing section is performed, screen data in which an arrangement position of commodity data of the target commodity is different from an arrangement position in the screen data generated by the generating section.
